(19) United States
(12) Patent Application Publication
(10) Pub. No.: US 2024/0204222 A1
(43) Pub. Date: Jun. 20, 2024

(54) ELECTRICITY-GENERATING SYSTEM, ELECTRICITY-GENERATING ASSEMBLY COMPRISING SUCH AN ELECTRICITY-GENERATING SYSTEM, AND TRAIN COMPRISING SUCH AN ELECTRICITY-GENERATING ASSEMBLY

(71) Applicant: ALSTOM Holdings, ST OUEN SUR SEINE (FR)

(72) Inventors: Christian CEBE, BELFORT (FR); Thibault VANDAMME, BELFORT (FR); Bruno CHIARANDINI, BELFORT (FR); Thierry TOURNIER, BELFORT (FR)

(21) Appl. No.: 18/545,873

(22) Filed: Dec. 19, 2023

(30) Foreign Application Priority Data
Dec. 20, 2022 (FR) 22 13962

(51) Int. Cl. H01M 8/04082; B61C 3/00; F17C 3/00; H01M 8/04089

(52) U.S. Cl. CPC H01M 8/04201; B61C 3/00; F17C 3/00; H01M 8/04089; F17C 2221/012; F17C 2270/0173; F17C 2270/0184; H01M 2250/20

(57) ABSTRACT

An electricity-generating system is configured to be carried on a trailer having a chassis. The electricity-generating system is of modular construction and includes a fluid storage module including a fluid storage device, and an electricity-generating module including an electricity-generating device configured to produce electricity from the fluid or fluids stored in the fluid storage device. The fluid storage module and the electricity-generating module are configured to be mounted on the chassis of the trailer. The fluid storage module is configured to be mounted in a removable manner on the chassis separately from the electricity-generating module.

### TECHNICAL FIELD

The present invention relates to the field of power supply for an electrically driven motor vehicle, and in particular to an electricity-generating system for such a motor vehicle.

### SUMMARY

One of the aims of the invention is to propose an electricity-generating system that is reliable, easy to use and allows a high degree of autonomy.

To this end, the invention proposes an electricity-generating system configured to be mounted on a trailer having a chassis, the electricity-generating system being of modular construction and comprising a fluid storage module comprising a fluid storage device and an electricity-generating module comprising an electricity-generating device configured to produce electricity from the fluid(s) stored in the fluid storage device, the fluid storage module and the electricity-generating module being configured to be mounted on the trailer chassis, the fluid storage module being separate from the electricity-generating module and configured to be mounted in a removable manner on the trailer chassis separately from the electricity-generating module.

The provision of an electricity-generating system configured to be mounted on a trailer allows the trailer to be coupled to an electrically driven motor vehicle, that is, a vehicle comprising at least one electric motor to ensure the driving of the vehicle, to supply the motor vehicle with electrical power from the trailer.

The electricity-generating device configured to produce electricity from at least one fluid stored in a fluid storage module allows a high degree of autonomy.

The provision of the fluid storage module on the trailer allows a large quantity of fluid to be taken on board, which allows a high degree of autonomy for a motor vehicle with which the electricity-generating system is associated.

The fluid storage module configured to be mounted on the trailer and removed from the trailer separately from the electricity-generating module containing the electricity-generating device, allows rapid replenishment of the electricity-generating system with fluid required for operation of the electricity-generating device, for example by replacing a fluid storage module, the fluid storage device of which is empty, with another fluid storage module the fluid storage device of which is full.

According to particular embodiments, the electricity-generating system comprises one or more of the following optional features, taken individually or according to any technically possible combinations:
the fluid storage module comprises a transport container, the fluid storage device being installed in the transport container;
the transport container of the fluid storage module is a standardized transport container;
the electricity-generating module is configured to be mounted in a removable manner on the trailer chassis;
the electricity-generating module comprises a transport container, the electricity-generating device being installed in the transport container of the electricity-generating module;
the transport container of the electricity-generating module is a standardized transport container;
it comprises an electricity storage device for storing electricity produced by the electricity-generating device;
the electricity storage device is integrated into the electricity-generating module or in an additional module separate from the fluid storage module and the electricity-generating module, the additional module preferably being configured to be mounted in a removable manner on the trailer chassis;
it comprises an electricity transformation device configured to transform the electricity produced by the electricity-generating device;
the electricity transformation device is integrated into the electricity-generating module or into an additional module separate from the fluid storage module and the electricity-generating module, the additional module preferably being configured to be mounted in a removable manner on the trailer chassis;
the electricity-generating device is configured to produce electricity by implementing a redox reaction from the fluid(s) stored in the fluid storage device;
the electricity-generating device comprises at least one fuel cell;
each fuel cell is of the hydrogen/oxygen type or of the hydrogen/air type.

The invention also relates to an electricity-generating assembly comprising a trailer having a chassis and an electricity-generating system as defined above, on board the trailer.

The invention further relates to a train comprising a motor vehicle having at least one electric traction motor, and, in addition, an electricity-generating assembly as defined above, of which the trailer is coupled to the motor vehicle and the electricity-generating system is connected to the motor vehicle for the supply of electric power to each electric traction motor.

### BRIEF DESCRIPTION OF THE DRAWINGS

The invention and its advantages will be better understood on reading the following description, given only as a non-limiting example, and made with reference to the appended drawings, on which:

FIG. 1 is a schematic side view of a train comprising an electrically driven motor vehicle to which is coupled a trailer on which an electricity-generating system is mounted for supplying electricity to the motor vehicle;

FIG. 2 is a more detailed schematic view of the trailer and the electricity-generating system mounted on the trailer;

FIG. 3 is a schematic side view illustrating the electricity-generating system mounted on the trailer.

FIG. 4 is a schematic side view illustrating another electricity-generating system mounted on the trailer.

### DETAILED DESCRIPTION OF PREFERRED EMBODIMENTS

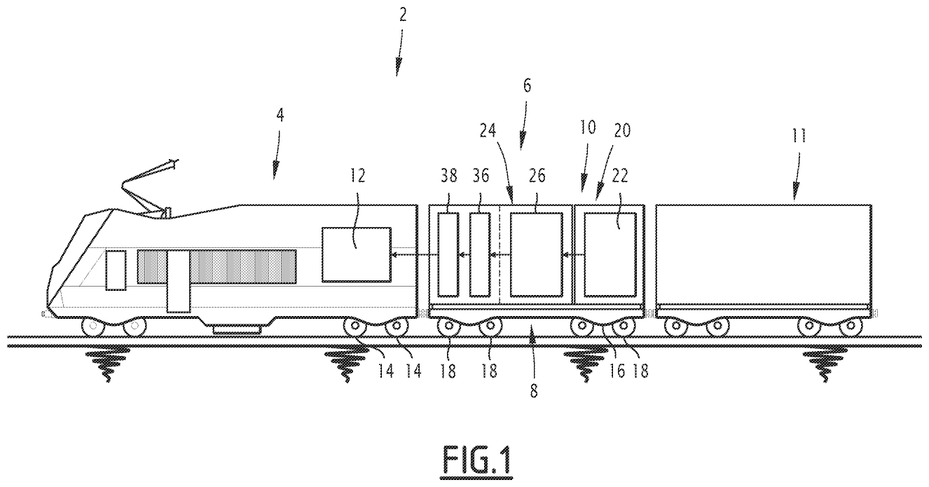

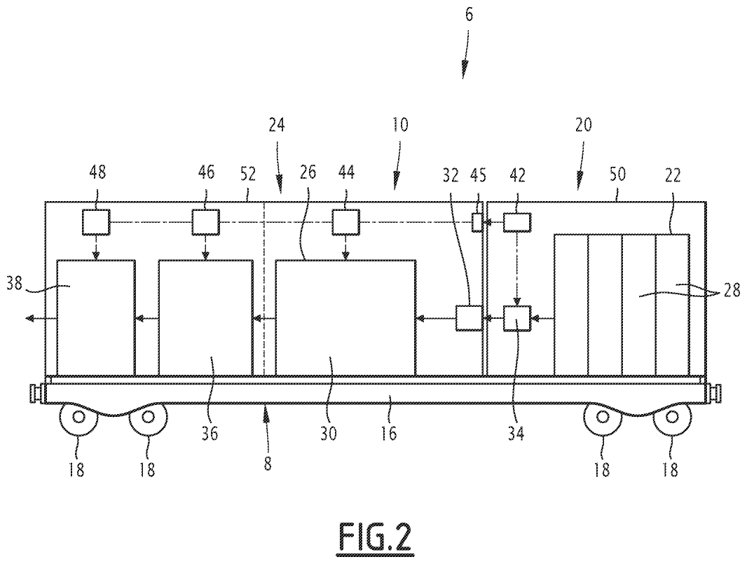

With reference to FIGS. 1 and 2, a train 2 comprises a motor vehicle 4 and an electricity-generating assembly 6, the electricity-generating assembly 6 comprising a trailer 8 coupled to the motor vehicle 4 and an electricity-generating system 10 configured for producing electricity, the electricity-generating system 10 being mounted on the trailer 8.

The train 2 is, for example, a railway train provided to run on a railway track. The motor vehicle 4 and the trailer 8 are also railway vehicles, more specifically a railway motor vehicle 4 and a railway trailer 8.

The train 2 optionally comprises one or more additional vehicles 11. An additional vehicle 11 coupled to the trailer 8 is shown in FIG. 1. Alternatively, several additional vehicles 11 may be provided. Each additional vehicle 11 is, for example, a passenger and/or freight vehicle.

The motor vehicle 4 is configured to generate a driving force and drive the other vehicles of the train 2 in which the motor vehicle 4 is integrated, including the trailer 8.

The motor vehicle 4 is electrically driven. The motor vehicle 4 is configured to use electrical energy to generate the driving force ensuring the driving of the motor vehicle 4.

The motor vehicle 4 comprises, for example, at least one electric traction motor or electric drive motor 12, configured to generate the driving force and ensure driving of the motor vehicle 4.

The motor vehicle 4 comprises at least one axle 14 which is motorized. Each motorized axle 14 is coupled to an electric drive motor 12 of the motor vehicle 4.

The motor vehicle 4 is, for example, a towing vehicle, in particular a locomotive. In this case, the motor vehicle 4 is only intended to drive the other vehicles of the train 2 in which the motor vehicle 4 is integrated. Alternatively, the motor vehicle 4 is configured to carry passengers and/or to carry freight.

The trailer 8 is a towed vehicle. The trailer 8 does not have a motor provided to generate a driving force to ensure drive for the trailer 8.

The trailer 8 is configured to be coupled to the motor vehicle 4 to form a train 2 in which the trailer 8 is driven by the motor vehicle 4.

The trailer 8 has a chassis 16 and at least one axle 18, the chassis 16 of the trailer 8 resting on each axle 18 of the trailer 8. Each axle 18 of the trailer 8 is non-motorized.

The electricity-generating system 10 is configured to produce electricity from at least one fluid and to supply the motor vehicle 4 with the electricity required to generate the driving force.

The electricity-generating system 10 is of modular construction. It comprises a number of separate modules, configured to be selectively combined to form the electricity-generating system 10 or separated.

The modules are fluidly and/or electrically connected to each other, in a removable manner, to form the electricity-generating system 10.

Preferably, at least one of the modules is configured to be mounted in a removable manner on the trailer 8. In particular, each module is configured to be mounted in a removable manner on the trailer 8.

Each module configured to be mounted in a removable manner on the trailer 8 is transportable as a single unit, for example using a lifting tool, such as a crane, overhead crane or forklift.

Preferably, each module of the electricity-generating system 10 is interchangeable with another module of the same type or identical. Thus, a defective module can be quickly changed with a module of the same type or identical, simply by removing the defective module from the trailer 8 and replacing it with another operational module.

The electricity-generating system 10 comprises a fluid storage module 20 comprising a fluid storage device 22 configured for the storage of one or more fluids.

The electricity-generating system 10 comprises an electricity-generating module 24 comprising an electricity-generating device 26 configured to produce electricity from the fluid(s) stored in the fluid storage device 22.

The fluid storage module 20 and the electricity-generating module 24 are separate.

As illustrated in FIG. 2, the fluid storage device 22 preferably comprises at least one reservoir 28, each reservoir 28 being configured for the storage of a fluid used by the electricity-generating device 26 to produce electricity.

The fluid storage device 22 preferably comprises several reservoirs 28, arranged for example side by side.

The electricity-generating device 26 is configured, for example, to produce electricity by implementing a redox reaction between a fuel contained in a fuel fluid and an oxidizer contained in an oxidizer fluid.

Each reservoir 28 of the fluid storage device 22 is then configured to receive the oxidizing fluid containing the oxidizing fluid or fuel fluid containing fuel.

The electricity-generating device 26 is configured, for example, to use dihydrogen as a fuel and dioxygen as an oxidizer. The fuel fluid is, for example, dihydrogen. The oxidizing fluid is, for example, dioxygen or air, which contains dioxygen.

In one example, the electricity-generating device 26 is configured to produce electricity by implementing a redox reaction using dihydrogen as the fuel fluid and air as the oxidizing fluid.

In this case, the fluid storage device 22 stores, for example, the dihydrogen required to implement the redox reaction, while the air required to implement the redox reaction is taken from the surrounding air. Preferably, each reservoir 28 is then supplied with dihydrogen.

Alternatively, the electricity-generating device 26 is configured to produce electricity by implementing a redox reaction between dihydrogen used as a fuel fluid and dioxygen used as an oxidizing fluid.

In this case, the fluid storage device 22 stores, for example, the dihydrogen required to implement the redox reaction and the dioxygen required to implement the redox reaction. Preferably, at least one reservoir 28 is filled with dihydrogen and at least one reservoir 28 is filled with dioxygen.

The electricity-generating device 26 comprises, for example, one or more fuel cells 30.

Each fuel cell 30 is an electrochemical reactor configured to carry out a redox reaction between a fuel contained in a fuel fluid and an oxidizer contained in an oxidizing fluid.

Each fuel cell 30 is configured, for example, to use dihydrogen as fuel and dioxygen as oxidizer.

In one example, each fuel cell 30 is a hydrogen/air fuel cell using dihydrogen as the fuel fluid and air as the oxidizing fluid.

Alternatively, each fuel cell 30 is a hydrogen/oxygen fuel cell using dihydrogen as the fuel fluid and dioxygen as the oxidizing fluid.

The electricity-generating system 10 comprises a fluid connection device 32 configured for fluidly connecting in a removable manner the electricity-generating device 26 and the fluid storage device 22.

The fluid connection device 32 is configured to selectively fluidly connect or disconnect the electricity-generating device 26 and the fluid storage device 22.

The fluid connection device 32 is configured to supply the electricity-generating device 26 with each fluid stored in the fluid storage device 22 and necessary for the production of electricity, when the fluid connection device 32 connects the electricity-generating device 26 to the fluid storage device 22.

Optionally, the electricity-generating system 10 comprises a distribution device 34 configured to distribute the fluid(s) stored in the fluid storage device 22 to the electricity-generating device 26 in a controlled manner.

The distribution device 34 has the components necessary to control the flow of the fluid(s) from the fluid storage device 22 to the electricity-generating device 26.

These components, for example, include pipes, fittings, regulators, valves and/or sensors, pressure and/or flow sensors.

The distribution device 34 is, for example, integrated into the fluid storage module 20.

The fluid connection device 32 is, for example, fluidly arranged between the distribution device 34 and the electricity-generating device 26.

Optionally, the electricity-generating system 10 comprises an electricity storage device 36 configured for storage of electricity produced by the electricity-generating device 26.

The electricity storage device 36 allows the electricity produced by the electricity-generating device 26 to be stored, then, subsequently use of this electricity to supply the motor vehicle 4 with electricity.

The electricity storage device 36 comprises, for example, one or more electrical accumulators. Each electrical accumulator is preferably an electrochemical accumulator.

Optionally, the electricity-generating system 10 comprises an electricity transformation device 38 configured to modify the voltage, current and/or type of current (direct or alternating) of the electricity produced by the electricity-generating device 26 and/or, where applicable, of the electricity stored in the electricity storage device 36, for use by the motor vehicle 4.

The transformation of the electricity produced by the electricity-generating device 26 or stored in the electricity storage device 36, allows the characteristics of the electricity produced by the electricity-generating device 26 to be matched to those of the electricity required to supply electricity to the motor vehicle 4, in particular to each electric drive motor 12 of the motor vehicle 4.

The electricity transformation device 38 comprises, for example, one or more electrical transformers for modifying the voltage, intensity and/or type of current (alternating current and/or direct current) of the electricity produced by the electricity-generating device 26 or possibly stored in the electricity storage device 36.

The electricity transformation device 38 is configured, for example, to be electrically connected between the electricity storage device 36 and the motor vehicle 4.

The electricity storage device 36 is, for example, electrically arranged between the electricity-generating device 26 and the electricity transformation device 38.

The electricity-generating system 10 comprises one or more electronic control units for controlling the fluid storage device 22, the electricity-generating device 26, if applicable, the power storage device 36, and, if applicable, the electricity conversion device 38.

The electricity-generating system 10 comprises, for example, an electronic distribution control unit 42 configured to control the distribution device 34. Preferably, the electronic distribution control unit 42 is installed in the fluid storage module 20.

The electricity-generating system 10 comprises, for example, an electronic generation control unit 44 configured to control the electricity-generating device 26. Preferably, the electronic generation control unit 44 is installed in the electricity-generating module 24.

Preferably, the electricity-generating system 10 is configured for a removable electrical connection of the fluid storage module 20 and the electricity-generating module 24, in particular for electrical connection of the electronic distribution control unit 42 and the electronic generation control unit 44, for example using an electrical connection device 45.

The electricity-generating system 10 comprises, for example, an electronic storage control unit 46 configured to control the electricity storage device 36.

The electricity-generating system 10 comprises, for example, an electronic transformation control unit 48 configured to control the electricity transformation device 38.

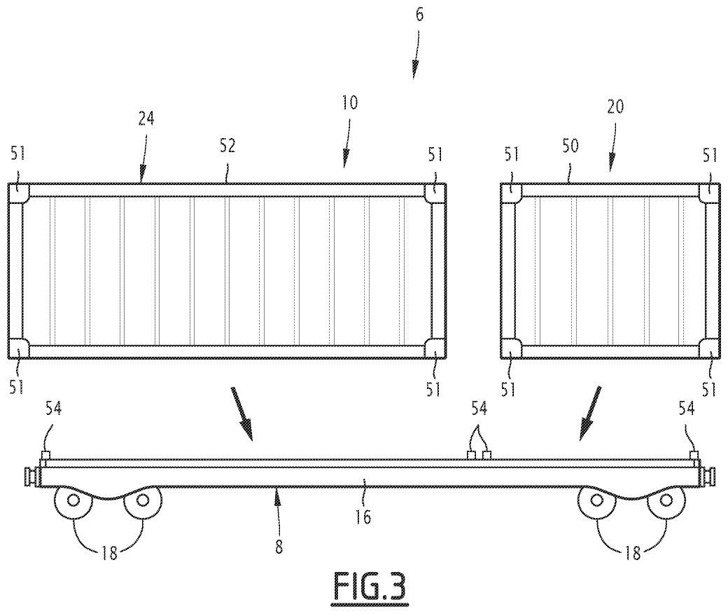

As illustrated in FIG. 3, the fluid storage module 20 is configured to be mounted in a removable manner on the chassis 16 of the trailer 8.

The fluid storage module 20 is transportable as a single unit, to be loaded onto the trailer 8 or removed from the trailer 8, for example using a lifting tool, such as a crane, an overhead crane or a forklift.

The fluid storage module 20 is configured to be mounted on the chassis 16 and removed from the chassis 16 of the trailer 8 separately from the electricity-generating module 24.

In particular, the fluid storage module 20 is configured to be able to be mounted on the chassis 16 of the trailer 8 and removable from the chassis 16 of the trailer 8 while leaving the electricity-generating module 24 on the chassis 16 of the trailer 8.

Preferably, the fluid storage module 20 comprises a transport container 50, the fluid storage device 22 being installed in the transport container 50 of the fluid storage module 20.

The transport container 50 of the fluid storage module 20 is configured to allow transport of the fluid storage module 20 including the fluid storage device 22 installed in the transport container 50 of the fluid storage module 20.

The transport container 50 is transportable, for example using a lifting tool, such as a crane, an overhead crane or a forklift truck.

The transport container 50 is preferably a standardized transport container.

A “standardized transport container” refers to a container specifically designed for road, rail and/or sea transport. Such a container is also known as an “international transport container” or “intermodal transport container” or “maritime transport container”.

A standardized transport container conforms, for example, to standard ISO 668 and/or standard ISO 1496.

Each standardized transport container has corner pieces 51 located at the eight vertices of a rectangular parallelepiped. These corner pieces 51 are precisely spaced and present standardized anchoring openings, conforming, for example, to standard ISO 1161. These corner pieces 51 are used to secure standardized transport containers and/or to fasten standardized transport containers together.

Each standard transport container can present a length of 10 feet, 20 feet, 30 feet, 40 feet or 45 feet. In a known manner, 1 foot corresponds to 30.48 cm.

Advantageously, the trailer 8 is a container trailer, that is, a trailer configured to receive standardized transport containers.

To this end, the chassis 16 of the trailer 8 is, for example, fitted with lashing devices 54 configured to cooperate with the corner pieces 51 of a standardized transport container placed on the trailer 8 to secure the standardized transport container to the trailer 8.

Optionally, the electricity-generating module 24 is also configured to be mounted in a removable manner on the chassis 16 of the trailer 8.

Preferably, the electricity-generating module 24 is transportable as a single unit to be loaded onto the trailer 8 or removed from the trailer 8, for example using a lifting tool, such as a crane, an overhead crane or a forklift.

The electricity-generating module 24 is configured to be mounted in a removable manner on the chassis 16 of the trailer 8 separately from the fluid storage module 20.

In particular, the electricity-generating module 24 is configured to be mounted on the chassis 16 of the trailer 8 and removed from the chassis 14 of the trailer 8 while leaving the fluid storage module 20 on the chassis 14 of the trailer 8.

The electricity-generating module 24 comprises, for example, a transport container 52, the electricity-generating device 26 being installed in the transport container 52. The transport container 52 is preferably a standardized transport container.

If an electricity storage device 36 is provided, the electricity storage device 36 is for example, integrated into the electricity-generating module 24. In particular, the electricity storage device 36 is installed in the transport container 52 in which the electricity-generating device 26 is installed.

If an electricity transformation device 38 is provided, the electricity transformation device 38 is, for example, integrated into the electricity-generating module 24. In particular, the electricity transformation device 38 is installed in the transport container 52 in which the electricity-generating device 26 is arranged.

In one example, the electricity-generating system 10 comprises exactly two modules, each configured to be mounted in a removable manner on the trailer 8, namely the fluid storage module 20 comprising the transport container 50 in which the fluid storage device 22 is installed, and the electricity-generating module 24 comprising the transport container 52 in which the electricity-generating device 26 is installed, as well as, optionally, the electricity storage device 36 and/or the electricity transformation device 38.

In one example, the transport container 50 of the fluid storage module 20 has a length of 10 feet or 20 feet and the transport container 52 of the electricity-generating module 24 has a length of 30 feet, 40 feet or 45 feet.

In one particular example of the embodiment, the transport container 50 of the fluid storage module 20, is 20 feet long and the transport container 52 of the electricity-generating module 24, is 30 feet or 40 feet long.

This allows using container trailer 8 that is 50 or 60 foot long and capable to receive the transport container 50 of the fluid storage module 20 and the transport container 52 of the electricity-generating module 24 arranged one behind the other on the chassis 16 of the trailer 8.

It is possible to provide more than two modules, for example by providing at least one additional module separate from the fluid storage module and the electricity-generating module.

Each additional module is preferably configured to be transportable as a single unit, for example by a lifting tool, and being able to be mounted on the trailer 8 and removed from the trailer 8 separately from the fluid storage module 20 and the electricity-generating module 24.

Each additional module comprises, for example, a transport container, which is preferably a standardized transport container.

The electricity-generating system 10 comprises, for example, at least one additional module comprising an electricity storage device 36 and/or an electricity transformation device 38.

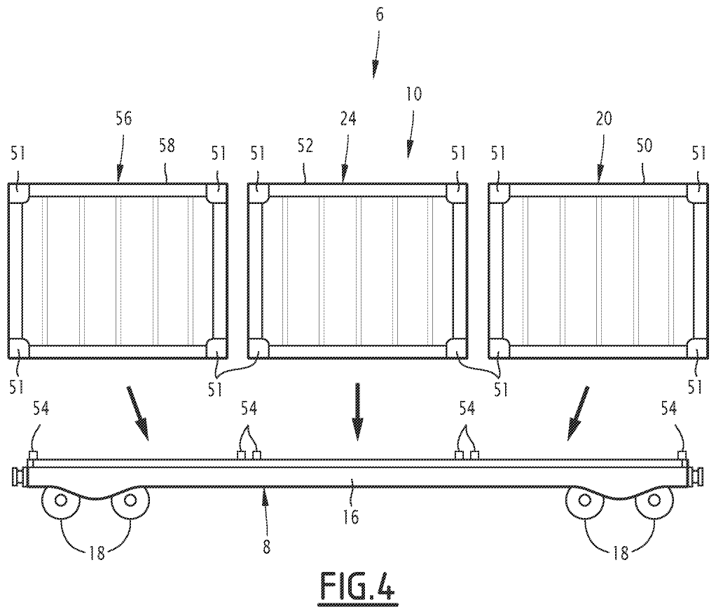

As illustrated in FIG. 4, in one example, the electricity-generating system 10 comprises an additional module 56 comprising an electricity storage device 36 and/or an electricity transformation device 38, which are preferably installed in a transport container 58, which is advantageously a standardized transport container.

Thus, the electricity-generating system 10 comprises three modules, namely the fluid storage module 20 comprising the fluid storage device 22, the electricity-generating module 24 comprising the electricity-generating device 26, and the additional module 56 containing the electricity storage device 36 and/or the electricity transformation device 38.

In particular, the three modules (fluid storage module 20, electricity-generating module 24 and additional module 56) each comprise a standardized transport container (transport containers 52, 56, 58), the standardized transport containers of the three modules being able to be mounted one behind the other on a chassis 16 of a railway trailer 8.

Other configurations are possible.

It is possible, for example, to integrate an electricity storage device 36 into the electricity-generating module 24, and to integrate the electricity transformation device 38 into an additional module 54 separate from the electricity-generating module 24.

The electricity-generating system 10 modules are configured to be connected to one another fluidly and/or electrically in a removable manner.

In particular, the fluid storage module 20 and the electricity-generating module 24 are configured to be fluidly connected to each other for the supply of the fluid(s) stored in the fluid storage device 22 to the electricity-generating device 26, and optionally electrically connected to each other, for example to connect an electronic distribution control unit and an electronic generation control unit.

When operating, the electricity-generating assembly 6, comprising the trailer 8 and the electricity-generating system 10 mounted on the trailer 8 is coupled to the motor vehicle 4.

One or more additional vehicles may be coupled to the trailer 8 and/or the motor vehicle 4.

The motor vehicle 4, the trailer 8 and any additional vehicle(s) form the train 2.

The electricity-generating device 26 produces electricity from the fluid(s) stored in the fluid storage device 22 and supplies the electricity to the motor vehicle 4, optionally by means of the electricity storage device 36 and/or the electricity transformation device 38.

When the train 2 comes to a halt, if the amount of fluid stored in the fluid storage device 22 is insufficient, it is possible to disconnect the fluid storage module 20 from the electricity-generating module 24, and replace the fluid storage module 20 with another fluid storage module 20 containing sufficient fluid.

This operation can be carried out simply and quickly, by manipulating the fluid storage module using a lifting tool.

There is no need for a filling station to refill the fluid storage device 22, just a replacement fluid storage module 20 with a filled fluid storage device 22.

The provision of an electricity-generating module 24 also mounted in a removable manner on the trailer 8 and configured to be connected in a removable manner to the fluid storage module 20 allows, for example, a rapid replacement of a faulty electricity-generating module 24 by another operational electricity-generating module 24. This avoids immobilizing the train 2 to carry out repairs on a faulty electricity-generating module 24.

The modular construction of the electricity-generating system 10 makes it possible to separate the different functions of the electricity-generating system 10 so that each module containing a faulty device can be replaced.

The invention is not limited to the above examples and alternatives. Other examples and alternatives are conceivable.

In particular, the invention is not limited to the railway sector, but may be applied to other sectors, such as the road sector. In this case, the motor vehicle 4 is a road vehicle and the trailer is a road trailer.

Furthermore, separate electronic control units have been illustrated in FIG. 2 for the different devices of the electricity-generating system (fluid storage device, electricity-generating device, electricity storage device and electricity transformation device).

Electronic control units for at least two devices can be combined in a single control computer, particularly when the two devices are integrated in a single module of the electricity-generating system 10.

What is claimed is:

1. An electricity-generating system configured to be mounted on a trailer having a chassis, the electricity-generating system being of modular construction and comprising a fluid storage module comprising a fluid storage device and an electricity-generating module comprising an electricity-generating device configured to produce electricity from fluid(s) stored in the fluid storage device, the fluid storage module and the electricity-generating module being configured to be mounted on the chassis of the trailer, the fluid storage module being separate from the electricity-generating module and configured to be mounted in a removable manner on the chassis of the trailer separately from the electricity-generating module.

2. The electricity-generating system according to claim 1, wherein the fluid storage module comprises a transport container, the fluid storage device being installed in the transport container.

3. The electricity-generating system according to claim 1, wherein the electricity-generating module is configured to be mounted in a removable manner on the chassis of the trailer.

4. The electricity-generating system according to claim 3, wherein the electricity-generating module comprises a transport container, the electricity-generating device being installed in the transport container of the electricity-generating module.

5. The electricity-generating system according to claim 1, comprising an electricity storage device for storing electricity produced by the electricity-generating device.

6. The electricity-generating system according to claim 5, wherein the electricity storage device is integrated into the electricity-generating module or into an additional module separate from the fluid storage module and the electricity-generating module

7. The electricity-generating system according to claim 6, wherein the additional module is configured to be mounted in a removable manner on the chassis of the trailer.

8. The electricity-generating system according to claim 1, comprising an electricity transformation device configured for transformation of the electricity produced by the electricity-generating device.

9. The electricity-generating system according to claim 8, wherein the electricity transformation device is integrated into the electricity-generating module or into an additional module separate from the fluid storage module and the electricity-generating module.

10. The electricity-generating system according to claim 9, wherein the additional module is configured for mounting in a removable manner on the chassis of the trailer.

11. The electricity-generating system according to claim 1, wherein the electricity-generating device is configured to produce electricity by implementing a redox reaction from the fluid or fluids stored in the fluid storage device.

12. The electricity-generating system according to claim 1, wherein the electricity-generating device comprises at least one fuel cell.

13. The electricity-generating system according to claim 12, wherein each fuel cell is of the hydrogen/oxygen type or of the hydrogen/air type.

14. An electricity-generating assembly comprising a trailer having a chassis and an electricity generating system according to claim 1 mounted on the trailer.

15. A train comprising a motor vehicle having at least one electric traction motor, and, in addition, the electricity-generating assembly according to claim 14, the trailer of which is coupled to the motor vehicle and the electricity-generating system is connected to the motor vehicle for the supply of electric power to each electric traction motor.
